(19) United States
(12) Patent Application Publication
(10) Pub. No.: US 2026/0041132 A1
(43) Pub. Date: Feb. 12, 2026

(54) PREFORMULATED PECTIN-BASED GUMMY PRECURSOR FOR MAKING STORAGE STABLE REDUCED SUGAR AND SUGAR-FREE PECTIN GUMMIES

(71) Applicant: M2M Gummies, LLC, Northampton, MA (US)

(72) Inventors: Siyue Gao, Northampton, MA (US); Sarah C. Walker-McLaughlin, Peterborough, NH (US)

(21) Appl. No.: 19/292,265

(22) Filed: Aug. 6, 2025

Related U.S. Application Data
(60) Provisional application No. 63/680,258, filed on Aug. 7, 2024.

(51) Int. Cl. A23L 29/231; A23G 3/34; A23G 3/36; A23G 3/38; A23G 3/42; A23L 29/00; A23L 33/21

(52) U.S. Cl. CPC A23L 29/231; A23G 3/0004; A23G 3/362; A23G 3/38; A23G 3/42; A23L 29/035; A23L 33/21

(57) ABSTRACT

A preformulated pectin-based melt-to-make bulk gummy mix is disclosed that is storage stable and formulated, optionally with flavors and colors, in a bulk mix form that is convenient for the next step in manufacturing storage stable individual serving reduced sugar or sugar-free pectin-based gummies. Methods for making a storage stable bulk pectin-based gummy mix that is a precursor for making individual serving reduced sugar or sugar-free pectin-based gummies are disclosed, as well as methods for making individual serving reduced sugar or sugar-free pectin-based gummies from a storage stable bulk pectin-based gummy mix. Kits comprising a two-part pectin-based gummy mix and acidulant for initiating pectin gelling are also described for the convenient manufacture of individual serving reduced sugar or sugar-free pectin-based gummies.

### RELATED APPLICATION

This application claims the benefit of U.S. Provisional Application No. 63/680,258, filed on Aug. 7, 2024. The entire teachings of the above application is incorporated herein by reference.

### BACKGROUND

Sugar free and reduced sugar pectin-based gummies are a popular confection but can be difficult to manufacture. There is a need for a quick and easy option for companies wishing to make pectin-based gummies that can be consistently and uniformly made.

### SUMMARY

The disclosure is based on the discovery of a pectin-based melt-to-make bulk gummy mix that is storage stable and preformulated, optionally with flavors and colors, in a bulk mix form that is convenient for the next step in manufacturing individual serving reduced sugar pectin-based gummies and individual serving sugar-free pectin gummies. The bulk preformulated pectin-based gummy mix can be used by companies making reduced sugar pectin-based gummies and/or sugar-free pectin-based gummies in a convenient manner to consistently manufacture storage stable reduced sugar and/or sugar-free pectin-based gummies in any size, and dose of a functional ingredient. Methods for making a storage stable bulk pectin-based gummy mix that is a precursor for making individual serving reduced sugar and/or sugar-free pectin gummies are disclosed, as well as methods for making individual serving reduced sugar and/or sugar-free pectin-based gummies from a storage stable bulk pectin-based gummy mix. Kits comprising a two-part pectin-based gummy mix and acidulant for initiating pectin gelling are also described for the convenient manufacture of individual serving reduced sugar and/or sugar-free pectin-based gummies.

### DETAILED DESCRIPTION

A description of example embodiments follows.

In one aspect, the disclosure pertains to methods of making a storage stable bulk pectin-based gummy mix that is a precursor for making reduced sugar and/or sugar-free pectin gummies (e.g., individual serving size). The bulk pectin-based gummy mix is a precursor because it is provided as a viscous, almost solid mixture that does not gel at room temperature. The bulk pectin-based gummy mix has a soluble solids level, as measured by dissolved solids level, below the target dissolved solids level of the final gelling gummy melt. This allows the bulk pectin-based gummy mix to be melted in the next step of the process of making pectin-based gummies (e.g., individual serving gummies). During the melting process, the dissolved solids level of the gummy mix are increased due to evaporation of the water in the melt, to achieve the final desired dissolved solids level of the gelling gummy melt. Once the target level of dissolved solids of the melt is achieved, an acidulant solution is added and the melt is ready to be deposited into molds for the individual serving gummies.

Pectin-based gummies that can be made with the pectin-based precursor can have a reduced sugar content in the finished pectin gummies. The term “reduced sugar” refers to the content of sugar in the finished gummies, relative to a similar pectin-based gummy that does not have its sugar/carbohydrates content reduced. This term is intended to encompass the categories of low-sugar, no-sugar, and sugar-free. For simplicity of discussion, the term herein will be generally referred to as “reduced sugar”. In an embodiment, the sugar content in the finished gummies is based on a serving size, which is typically a single gummy. The sugar content is also dependent upon the size of the single gummy. In one embodiment, a reduced sugar finished gummy will have about 2 grams of total carbohydrate, of which some of the total carbohydrate can be dietary fiber. In another embodiment, the finished gummy will be sugar-free and will contain less than 0.5 grams of sugar with some of the total carbohydrate from dietary fiber, preferably 0.0 grams of sugar.

An objective of the disclosure is to reduce or eliminate sugars in the bulk precursor formulation, sugars such as but not limited to fructose, glucose, sucrose or other simple or complex sugar that contributes to the sweetness, carbohydrate content and caloric value of the gummy. A reduction in the sugar content in the bulk precursor formulation will translate into a finished pectin-based gummy that will have a reduced sugar content or a sugar-free content, per serving.

A “finished” pectin-based gummy as used herein is intended to mean a gummy produced according to the methods of the disclosure using the pectin-based precursor. The finished pectin-based gummy can be an individual sized gummy that is consumed as a single unit dose. A single gummy can be made in any size and shape mold with individual compartments, such as 3.5, 2.5, 2.0, 1.5, 1.0 cm³ (cubic cm), to produce individual gummies that are for example, from about 1.34 grams to about 4.69 grams, with 2.5 grams being a preferred serving size. The gram size of the finished gummy is dependent on the density of the gummy precursor mix and the size of the mold compartment. The skilled person will understand that the size and shape of the finished gummies can be determined by the manufacturer and variations will depend on the desired reduced sugar content and labeling requirements for sugar content, for example, those promulgated under regulatory agency requirements.

Described herein is a bulk, meltable and storage stable preformulated pectin-based gummy mix that is a meltable precursor for making storage stable individual serving reduced sugar pectin-based gummies, the preformulated pectin-based gummy mix comprising:
a pectin-based gummy mix comprising dissolved pectin, optional buffering salt, bulking agent and/or sugar substitute and water, the amount collectively being present to achieve a dissolved solids content between about 60 to about 75, a pH of from about 4 to about 4.6 and a water activity of about 0.75 aw to about 0.85 aw; and optionally flavoring and/or coloring incorporated into the pectin-based gummy mix,
wherein sweetness is provided from the bulking agent and/or sugar substitute, and wherein the preformulated pectin-based gummy mix is storage stable and a meltable precursor for making storage stable individual serving reduced sugar pectin-based gummies.

In an embodiment, the preformulated bulk pectin-based gummy mix is a meltable precursor for making storage stable individual serving sugar-free pectin-based gummies.

The reduced sugar content of the finished gummy is achieved using sugar substitutes and/or bulking agents in the meltable preformulated precursor formulation, such as but not limited to sugar alcohols, artificial sweeteners, naturally derived low-calorie sweeteners, rare sugars, and fibers. The sweetness of the finished gummies is provided from the bulking agent and/or the sugar substitute.

Sugar alcohols (e.g., polyols) suitable for use in the precursor pectin-based gummy mix include but are not limited to erythritol, xylitol, sorbitol, maltitol, mannitol, isomalt, and lactitol. Sugar substitutes from artificial or natural sources suitable for inclusion in the pectin-based gummy precursor mix as a sweetener source, include but are not limited to, saccharin, aspartame, acesulfame potassium (Ace-K), sucralose, neotame, advantame trehalose, isomaltulose, and plant derived sweeteners, such as but not limited to Stevia and its derivatives (such as but not limited to Rebaudioside A (Reb A), stevioside, steviol glycosides, Stevia extract, Stevia leaf extract, Rebaudioside M (Reb M)), monk fruit. These are typically known as high intensity sweeteners. Use levels of erythritol in the compositions of the disclosure can be from about 4% by weight to about 7% by weight. For other sugar substitutes, such as maltitol, allulose, FOS, the usage level can be about 60% to about 95% by weight.

A “bulking agent” as the term is used herein is intended to include non-sweet (or low sweetness) ingredients such as fibers, rare sugars and non-digestible polysaccharides low molecular weight carbohydrates. A bulking agent can be incorporated into the pectin mixture to allow the pectin mixture, when heated, to achieve a target dissolved solids content without contributing to the sugar content of the finished gummy product. In one embodiment, the bulking agent contributes to the dissolved solids content but does not contribute to the sweetness or sugar content of the finished gummy product. In another embodiment, the bulking agent has dual functionality in that it contributes to the dissolved solids content and contributes to the sweetness of the finished gummy product. Depending on the intended dissolved solids content and the intended sweetness, the precursor mix can contain a bulking agent, a combination of bulking agent and sugar substitute, or just a sugar substitute. It will be appreciated that at least one bulking agent and/or at least one sugar substitute, and combinations can be used in the pectin-based precursor formulation.

Fibers suitable for use as a bulking agent in the disclosure include as but not limited to non-nutritive fibers, soluble fibers, such as but not limited to inulin (e.g., from sources such as but not limited to agave, chicory root, Jerusalem artichoke), corn fiber, tapioca fiber, chicory extract, cassava flour, polydextrose, Fructooligosaccharides (FOS), resistant maltodextrin, resistant dextrin, galactooligosaccharides (GOS), glucomannan, beta-glucan.

Rare sugars suitable for use as a bulking agent in this disclosure include but are not limited to Allulose (D-psicose), D-allulose, D-Tagatose, L-Sorbose, Allose, Apiose.

A “sugar-free” single serving finished gummy according to the disclosure will contain less than 0.5 grams of sugars, both natural and added, per serving. A serving size of less than 0.5 grams per 100 grams per serving can be labeled as sugar-free.

A “reduced sugar” single serving finished gummy according to the disclosure will contain at least about 25% to about 30% less sugars than the regular version of the product.

A “low sugar” single serving finished gummy according to the disclosure will contain no more than 5 g of sugars per 100 g.

In one embodiment, the bulking agent and/or sugar substitute is a combination of tapioca fiber and inulin. In another embodiment, the bulking agent and/or sugar substitute is a combination of tapioca fiber, inulin, and erythritol and/or other sugar alcohols (such as xylitol and maltitol) and/or high intensity sweetener, such as stevia or its derivatives, or monk fruit. In yet another embodiment, the bulking agent and/or sugar substitute is a combination of corn fiber, inulin and optionally erythritol and/or other sugar alcohols (such as xylitol and maltitol) and/or high intensity sweetener, such as stevia or its derivatives, or monk fruit. In other embodiments, the bulking agent but not a sugar substitute will be present provided that the bulking agent has a dual functionality to provide sweetness and dissolved solids. In an embodiment, the dual functional bulking agent is allulose, maltitol or FOS. In another embodiment, the bulking agent and/or sugar substitute is inulin, optionally with erythritol and/or other sugar alcohols (such as xylitol and maltitol) and/or high intensity sweetener, such as stevia or its derivatives, or monk fruit.

The combinations of bulking agent and/or sugar substitute should be selected to provide sweetness that does not impart a bitter after taste in the individual serving finished gummies. Further, the combination of bulking agent and/or sugar substitute should be selected to avoid crystallization of these in the finished gummies.

Methods of Making a Storage Stable Melt-to-Make Bulk Pectin-based Gummy Mix

The disclosure pertains to methods of making a preformulated, storage stable bulk pectin-based gummy mix that is a meltable precursor for making storage stable individual serving reduced sugar or sugar-free pectin-based gummies, comprising:
heating a pectin-based mixture comprising pectin, bulking agent and/or sugar substitute and optional buffering salt in water, for a period of time sufficient to dissolve the pectin-based mixture, the amount of ingredients in the pectin-based mixture collectively being present to achieve a dissolved solids content between about 60 to about 75, a pH of from about 4 to about 4.6 and a water activity of about 0.75 aw to about 0.85 aw, to produce a meltable pectin-based gummy mix that is a preformulated precursor for making storage stable individual serving reduced sugar or sugar-free pectin-based gummies, wherein the sweetness is provided from the bulking agent and/or the sugar substitute;
optionally adding flavoring and/or coloring to the pectin-based gummy mix before the mix is cooled; and
storing the preformulated pectin-based gummy mix in a container for a period of time before being used as a meltable precursor.

The amount of pectin, bulking agent and/or sugar substitute, optional buffering salt in the pectin-base mixture collectively should be present to achieve the desired dissolved solids level, gel strength and sweetness. Gel strength can be determined by sensory/mouthfeel and stability under storage conditions. Stability can be achieved by maintaining a water activity of less than 0.7 aw for the finished gummy.

As an example embodiment, a bulk pectin-based gummy mix is prepared by first combining together the dry ingredients which comprise or consist of pectin, acid powder, buffering salt and sugar substitute (collectively, dry mixture or powder ingredients). Separately, liquid ingredients, such as water, liquid low or no caloric sugar substitute, and/or a bulking agent are added to a vessel (heated kettle, tank or equivalent). The vessel with the liquid ingredients is heated and the dry mixture (powder ingredients) is incorporated into the heated liquid ingredients by mixing or under high shear. The mixture is heated for a period of time sufficient for the pectin and other ingredients to be fully dissolved (by visually inspecting the mixture to be free of clumps).

The mixture should continue to be heated to its boiling point for a period of time sufficient to achieve a desired total solid range of about 60 to about 75. A typical measurement for dissolved solids content is determined by Brix using a Brix meter. In one embodiment, the Brix measurement should be from about 57 Brix to about 75 Brix. The amount of time to heat the mixture to achieve the target dissolved solid level will depend upon the batch size. The target temperature range that should be regulated is about 90° C. to about 120° C. When the desired dissolved solid level is achieved, the heated mixture should be removed from the heat source. While the mixture is still hot, at least one other ingredient can be added, such as but not limited to flavors and/or colors, as further discussed below. The dissolved solids should be measured again after the addition of the at least one other ingredient to ensure that the dissolved solids level has not been significantly changed. The dissolves solids level can be corrected by adding water and measuring the dissolves solids. This is repeated until the desired solids level is reached.

It should be understood that adjustments in the process, such as temperature, ingredients, order of the ingredients, amounts and ratios of the ingredients can be adapted by the skilled person based on the teachings of the process herein and such adaptations are intended to be covered by this disclosure.

The percentages of the ingredients in the mixture (e.g., pectin, water, bulking agent and/or sugar substitute, optional buffering salt) are described below, with slight variations in these ratios to account for the addition of flavorings and coloring ingredients into the pectin mix. In an embodiment, the pectin, optional buffering salt and other dry ingredients are mixed together as a dry mix and then hydrated in water. In another embodiment, some of these ingredients are provided in liquid form to which the dry ingredients are then added. In yet another embodiment, the ingredients can be mixed together and then heated without concern for the order of addition. The order of addition and heating time to achieve the desired dissolved solids will depend upon the scale of the processing equipment. The methods of the disclosure are scalable for commercial production and can be automated. In an automated process, the liquid and dry ingredients are blended together in a premix vessel with a high shear mixer. Once blended the mixture moves to a cooker and then in some cases to a vacuumizer to cool the mass down. Once fully cooked the flavor, color, acids and additives can be added.

Pectin can be used in any form, such as liquid or powder forms. Preferably, the pectin will be powdered pectin as it can be conveniently dry blended with the dry ingredients described herein before it is hydrated. To ensure a target gel strength of the final product, the typical usage rates are about 1.0% to about 5% by weight (pectin):about 0% to about 0.8% by weight (buffering salt):about 60% to about 95% of bulking agent and/or sugar substitute by weight:about 5% to about 30% water by weight, with adjustments in the water to soluble solids to pectin ratio to achieve a desired texture and mouthfeel. The ratio may also be slightly varied depending upon the flavor and color added to the pectin-based mix. Ultimately, the final texture of the individual serving gummies is achieved after demolding during the curing/drying process. More drying time leads to a firmer and chewy individual serving gummy.

Particularly preferred types of pectin are high methoxyl pectins (HM). Suitable HM pectin that can be used in the products and methods of the disclosure include but are not limited to citrus and apple derived pectins. Other types of pectin that could be used include low methoxyl pectin (LM) and low methoxyl amidated pectins.

Buffering salt as used herein refers to an edible salt that can buffer the pectin-based gummy mix to a desired pH level when the acidulant is added to the pectin-based gummy mix, to initiate the gelling process. The buffering salt can also act as a retarder to slow down the gelling process so that the gummy melt can be deposited into molds before the pectin-based melt is fully gelled. Suitable buffering salts include but are not limited to sodium citrate, sodium tartrate, potassium tartrate, calcium citrate, potassium polyphosphate or potassium citrate. Preferably, the buffering salt is sodium citrate. The usage level of the buffering salt is subject to the specific type of buffering salt and acidulant to achieve the target pH level of the mixture. For example, the usage level of buffering salt will be from about 0% to about 0.8% by weight. The purpose of maintaining a controlled pH is to prevent pre-gelling while making the pectin-based gummy mix and upon adding the acidulant in the final step of making the finished gummies. The skilled person will be able to ascertain the edible buffering salt and acidulant combinations that can be used in the formulations and methods of this disclosure, to achieve a stable pH of the individual finished gummies. The selection of buffering salt and acidulant in the gummy mix precursor and the use amounts will depend on the desired pH and sensory properties (e.g., taste, sourness, tartness and smell) of the individual serving gummies. The skilled person will be able to know how to balance the buffering salt and acidulant amounts with these intended objectives in mind based on the teachings of the disclosure.

Acid to be incorporated into the pectin mixture before heat processing can be a dry or liquid acid in an amount to achieve a desired pH of the gummy precursor, for example a pH of from about 4.0 to about 4.6. A suitable acid is an organic acid from plant source, microbial fermentation or synthetic sources that is safe for human consumption. The purpose of the acid is to achieve a desired pH and sensory properties (e.g., taste, sourness, tartness and smell) to the individual serving gummies. Suitable food grade edible acids include but are not limited to citric acid, tartaric acid, lactic acid, fumaric acid, malic acid, citrus juice, acetic acid, apple cider vinegar, ascorbic acid and other organic acids that would be known to the skilled person for the purpose of adjusting the pH and optionally to impart sensory or organoleptic properties, such as a tart or sour flavor, to the finished individual serving gummies.

The ratio of water to pectin and other dry ingredients should be sufficient to achieve an ideal texture to form a gel when combining the pectin-based gummy mix and the acidulant together (e.g., part A and part B, as described herein) to make the final gelling bulk gummy mixture. The temperature of the water and precursor gummy mixture should be controlled so that the final dissolved solids value is controlled. The temperature should be maintained at about the boiling point of the mixture, preferably at about 90° C. to about 110° C., or until the pectin and other dry ingredients have been dissolved.

The gummy mix can be pasteurized using know pasteurization methodologies, and then stored in a storage container. Pasteurization will aid in product stability and shelf life.

While the pectin-based gummy mix of the disclosure is still hot, it can be further processed to add one or more other ingredients, such as but not limited to acidulants, preservatives, flavoring agents, coloring agent, isolates, distillates, extracts, functional ingredients. Functional ingredients are those that are usually administered in a supplement form (vitamin, minerals, melatonin, L-Theanine, caffeine). It should be understood that the other ingredients will be selected based upon desired labeling of the end product gummies, such as maintaining the vegan or vegetarian status of the gummies. While one or more of these ingredients are optional in the bulk pectin-based gummy mix, the customer making the individual serving gummies from the bulk pectin-based gummy mix will need to incorporate one or more of these other ingredients into the melt to make a finished product to meet the needs of the consumer.

If one or more other ingredients are to be incorporated into the bulk pectin-based gummy mix, they should be added to the dissolved pectin mixture at the end of the final cooking process. The timing for adding the other ingredients will depend on the nature of the ingredients and whether they are heat sensitive ingredients (e.g. natural color and flavors). Heat sensitive ingredients should be added at the end of the process to avoid extended exposure to heat. Some functional ingredients should be added to the water along with pectin to dissolve. The skilled person should be able to ascertain the appropriate step in the process for incorporating other ingredients. In one embodiment, the bulk gummy mix does not include other ingredients so that the end user can have the flexibility to add other ingredients of their choice. In another embodiment, the bulk gummy mix comprises at least one or more other ingredients so that the end user does not have to add those ingredients. The end user can add additional ingredients beyond those incorporated into the bulk gummy mix.

After the at least one or more other ingredients have been incorporated into the pectin-based gummy mix, the dissolved solids content of the pectin-based gummy mix should be measured to ensure that the dissolved solids are still within the desired range. In an embodiment, the dissolved solids should be from about 60 to about 75 (about 57 Brix to about 75 Brix).

The pectin-based gummy mix is then transferred into a container, such as a sterilized container, and sealed for storage. It is desirable to transfer the gummy mix to a container while it is still hot, as the cooled pectin-based gummy mix is a semi-solid having a very high viscosity at room temperature. Because of its viscous nature at room temperature, the bulk gummy mix will need to be melted before the citric acid or other acidulant solution can be added to the pectin-based gummy mix during the process of making individual gummies. The bulk pectin-based gummy mix is referred to as a “melt-to-make” product because it can be melted, acidulated, and formed into individual serving gummies in a consistent manner in any size and dose. The preformulated bulk pectin-based gummy mix is storage stable in dry storage conditions, with a final pH level between about 4.0 to about 4.6 and water activity in the range of about 0.75 aw to about 0.85 aw.

The batch size of the gummy mix, as specified by the manufacturer, will determine the number of individual serving gummies that can be produced in a batch. The ratio of ingredients, pH and Brix should be selected to ensure that the pectin-based gummy mix is storage stable.

### Method of Making a Bulk Acidulant Solution for Use in Initiating the Gelling Process

The pH of the pectin-based gummy mix must be adjusted in order to initiate the gelling of the pectin-based gummy mix. Preferably, the pH of the gummy mix should be about 3.0 to about 3.7 to initiate the gelling process. The pH of the finished individual serving gummies should be about 3.0 to about 3.7.

In one embodiment, this is achieved with a bulk citric acid or other acidulant solution in a concentration that can be conveniently added to the bulk pectin-based gummy mix in the melted state. When the acidulant is a citric acid solution, the citric acid is provided in a concentration of from about 40% by weight to about 60% by weight in water. In a preferred embodiment, the citric acid solution is about 50% by weight in water. If an acidulant other than citric acid is used, the concentration of the solution will be from about 40% by weight to about 60% by weight in water. The use level of the bulk acidulant to be added in the pectin-based gummy mix to initiate gelling will depend upon the amount and type of buffering salt and the desired pH of the final combined mixture.

In one embodiment, a bulk citric acid or other acidulant solution can be made by dissolving citric acid or other acidulant in water at elevated temperature of from about 162° F. to about 165° F. for a period of time sufficient to dissolve the citric acid or other acidulant, such as for about 15 seconds. The citric acid or other acidulant solution is cooled and stored, for example in a sanitized container that is suitable for storage.

It is desirable to make a bulk quantity of the citric acid or other acidulant solution that would be suitable to incorporate into the bulk gummy mix melt. In one embodiment, the amount of the two components (bulk pectin-based gummy and acidulant) can be conveniently mixed together to produce a gelling mixture to make individual gummies. In another embodiment, the amount of the bulk citric acid or other acidulant solution provided is sufficient to use the solution in aliquots depending upon the amount of gummy mix portioned out from the bulk mix to produce a less than full quantity of individual gummies.

Suitable food grade edible acids that can serve as the acidulant in the products and methods of the disclosure include but are not limited to citric acid, tartaric acid, lactic acid, fumaric acid, malic acid, citrus juice, acetic acid, apple cider vinegar, ascorbic acid and other organic acids that would be known to the skilled person for the purpose of initiating the gelling process at a target pH and optionally to impart sensory or organoleptic properties, such as a tart or sour flavor, to the finished individual serving gummies.

The amount of acidulant added in the pectin gummy making process is restricted by the final pH of the pectin mix prior to depositing. The pH of the finished individual serving gummies should be about 3.0 to about 3.7. In an embodiment, the amount of acidulant solution added to the pectin-based gummy melt is from about 0.4% by weight to about 2.5% by weight in the batch size to make individual gummies based on the total weight of all the components in the gummy mixture, including colors, flavors, and the acid solution, optional functional ingredients.

In another embodiment, the gummy manufacturer can prepare their own acidulant solution, such as a citric acid solution, and incorporate it into the bulk pectin-based gummy mix, using the methods described herein, to make individual serving gummies.

### Storage Stable Bulk Melt-to-Make Pectin-Based Gummy Mix

The disclosure also pertains to a storage stable melt-to-make bulk pectin-based gummy mix that is a meltable precursor ingredient for making individual serving reduced sugar or sugar-free pectin gummies. The bulk pectin-based gummy mix comprises a pectin-based gummy mix comprising dissolved pectin, optional buffering salt, bulking agent and/or sugar substitute and water, and having a dissolved solid content between about 60 to about 75 (about 57 Brix to about 75 Brix), wherein sweetness is provided from the bulking agent and/or the sugar substitute, and optionally comprises flavoring and/or coloring incorporated into the pectin-based gummy mix.

In one embodiment, the buffering salt will be present in the meltable pectin-based gummy mix, where the buffering salt is selected from sodium citrate, potassium polyphosphate, sodium tartrate, potassium tartrate, calcium citrate or potassium citrate, or combination of these. In another embodiment, the buffering salt is sodium citrate.

In another embodiment, the pectin will be a buffering pectin. Use of a buffering pectin will provide flexibility in making a formulation that can handle the addition of an edible food grade acid, to achieve a desired pH and/or organoleptic properties.

The bulk pectin-based gummy mix will have a dissolved solid content of between about 60 to about 75 (about 57 Brix to about 75 Brix). The dissolved solids content can be determined by the skilled person using known methodologies. In an embodiment, the dissolved solids content can be measured using a Brix meter to obtain a measurement in Brix. In another embodiment, the Brix value can be converted using the equation provided herein to more closely approximate the dissolved solid content of the gummy mix since Brix is a measurement of sucrose. Regardless of the way that the manufacturer chooses to measure the dissolved solids content of the bulk pectin-based gummy mix, the level of dissolved solids will need to be below the target dissolved solids level of the final gelling gummy melt. This is because during the melting process, the dissolved solids of the gummy mix will increase due to evaporation of the water in the melt. The evaporation process proceeds until the final dissolved solids in the gummy melt is achieved. The dissolved solid content in the gummy melt will be between about 75 to about 80 (about 70 Brix to about 80 Brix).

In addition to reaching a target dissolved solid content in the melt, the gelling process is initiated by the addition of citric acid or other acidulant solution in an amount to reach a pH of from about 3.0 to about 3.7. The melt is ready to be deposited into molds for the individual serving reduced sugar or sugar-free pectin-based gummies.

The quantity of pectin-based gummy mix in a bulk package will be determined by the manufacturer and will depend upon factors including but not limited to the quantity of individual serving gummies that can be made from the bulk gummy mix, and shipping in an economic manner. In some embodiments, the pectin-based gummy mix is provided in bulk quantities from about 500 g to multi-kilogram quantities, and even larger quantities. It should be understood that the quantity of the precursor pectin-based precursor mix can vary depending on the number of finished gummies desired, to be produced in a single batch or plurality of batches.

In one embodiment, the bulk gummy mix does not include other ingredients so that the end user can have the flexibility to add those ingredients of their choice. In another embodiment, the bulk gummy mix comprises at least one or more other ingredients so that the end user does not have to add those ingredients. The end user can add additional ingredients beyond those incorporated into the bulk gummy mix such as but not limited to acidulants, preservatives, flavoring agents, coloring agents, isolates, distillates, extracts, functional ingredients such as but not limited to vitamins, minerals, caffeine, melatonin, plant extracts. Cannabis/CBD extracts, THC, amino acids or other extracts, L-Theanine, ascorbic acid or zinc.

While one or more other ingredients are optional in the bulk pectin-based gummy mix, the customer making the individual serving gummies from the bulk pectin-based gummy mix, made by the methods of this disclosure, will need to incorporate one or more of these ingredients into the melt to make a finished product to meet the needs of the consumer.

Examples of flavors that can be used in the products and methods of the disclosure include but are not limited to apple, grape, cranberry, pomegranate, pear, peach, pineapple, cherry, melon (watermelon, cantaloupe), plum, kiwi, mango, banana, papaya, apricot, acai, citrus fruits including but not limited to lemon, orange, tangerine, grapefruit and lime; and berries including but not limited to strawberry, blackberry, boysenberry, raspberry, blueberry, currants. In preferred embodiments, the colors and flavors should be from all-natural sources.

### Two-Part Pectin-Based Gummy Mix for Making Individual Serving Reduced Sugar or Sugar-Free Gummies

In some embodiments of the disclosure, the meltable and storage stable bulk pectin-based gummy mix and acidulant are provided in two separate parts as precursors for making individual serving gummies and when added together under appropriate conditions of pH and temperature will initiate the gelling process. Part A comprises a preformulated, meltable and storage stable pectin-based gummy mix comprising pectin, optional buffering salt (e.g., sodium citrate or others as provided in this disclosure), bulking agent and/or sugar substitute and water, and having a dissolved solids content of from about 60 to about 75 (about 57 Brix to about 75 Brix), a pH of from about 4 to about 4.6 and a water activity of about 0.75 aw to about 0.85 aw, and optionally comprising flavoring and/or coloring. Part A is referred to herein as the bulk pectin-based gummy mix. Methods of making the bulk pectin-based gummy mix using the two-part system are described herein.

Part B is an acidulant comprising a solution of from about 40% by weight to about 60% by weight citric acid or other acid dissolved in water. When part B is added to part A, the pectin-based gummy mix will be acidified to a pH of about 3.0 to 3.7, to thereby facilitate gelling of the pectin. In one embodiment, the part B acid solution will be added to part A in an amount of from about 0.4% to about 2.5%. In an embodiment, an about 50% by weight citric acid solution is added. Other use levels of the citric acid solution or other acidulant are contemplated and are dependent upon variables of concentration, pH, pectin type and concentration of dissolved solids. The amount of acid needed can vary with addition of functional ingredients, coloring, flavoring, fruit juices that affect the pH of the mixture.

In another embodiment, the disclosure provides for a kit for making individual serving reduced sugar pectin-based gummies from bulk quantities of ingredients in a convenient and consistently reproducible manner. In one embodiment, the kit will comprise containers separately storing part A and part B of the two-part bulk pectin-based gummy mix; and instructions for mixing part A and part B to make individual serving gummies. In another embodiment of the kit, the kit will include a container comprising part A (the pectin-based gummy mix) and instructions for making part B (citric acid or other acidulant solution) and then combining part A and part B together to make individual serving gummies. The kit can optionally include other components/ingredients that could be useful in making individual serving gummies, such as but not limited to anti-stick agents, oil, wax, starch and other low calorie coatings, non-nutritive sugar replacement as a sanding sugar or other coatings depending on the customers preference, functional ingredients, like L-Theanine, ascorbic acid or zinc or equipment that can aid in the manufacturing process, like gummy molds and scrapers.

The quantities of part A and optionally part B in the kits will be determined by the manufacturer and will depend upon factors including but not limited to the quantity of individual serving reduced sugar gummies that can be made from the bulk gummy mix, and shipping of the kits in an economic manner. Single or multiple batches of individual serving reduced sugar gummies can be made using the bulk pectin-based gummy mix or kits described herein, depending upon customer intended use. In one embodiment, the kit will comprise about 10 kg of part A pectin-based gummy precursor mix and about 150 g of part B acidulant. It should be understood that the quantity of part A and part B in the kit can vary depending on the number of finished gummies desired, to be produced in a single batch or plurality of batches. In embodiments, the quantity of part A in the kit can range from about 100 grams to about 1500 kilograms, and even larger quantities.

### Methods for Making Individual Serving Reduced Sugar or Sugar-Free Gummies

The bulk pectin-based gummy mix produced by the methods of the disclosure are used as a bulk intermediate or precursor to create individual serving reduced sugar or sugar-free pectin-based gummies. Because the preformulated bulk gummy mix is storage stable and meltable, it provides a convenient starting point for the gummy manufacturer to make individual serving reduced sugar or sugar-free pectin-based gummies that are consistent in formulation and ingredients.

Described is a method for making storage stable individual serving reduced sugar or sugar-free pectin-based gummies using a preformulated, storage stable, meltable bulk pectin-based gummy mix, comprising:
heating the pectin-based gummy mix to a temperature to prevent pre-gelling and to solubilize the solids in the mix to achieve a dissolved solids measurement of about 75 to about 80, to create a pectin-based gummy melt having a water activity of about 0.55 to about 0.70 aw;
optionally incorporating at least one other ingredient into the pectin-based gummy melt and adjusting the dissolved solids measurement, if needed, to about 75 to about 80;
mixing an acidulant into the heated pectin-based gummy melt to achieve a pH of from about 3.0 to about 3.7, to thereby initiate gelling of the pectin; and
depositing the pectin-based gummy melt into individual serving molds and allowing the pectin-based gummy melt cool and gel to produce storage stable individual serving reduced sugar or sugar-free pectin-based gummies.

According to an embodiment, individual serving reduced sugar or sugar-free pectin-based gummies are made by a method comprising melting the bulk pectin-based gummy mix produced by the methods of the disclosure (e.g., part A) to create a melt; optionally incorporating at least one other ingredient into the melt; acidulating the melt with a citric acid solution or other acidulant (e.g., part B as described herein), and pouring the melt into individual serving molds and allowing the melt to gel to produce individual serving reduced sugar pectin-based gummies.

The gummy mix is melted under conditions to create a melt having a dissolved solids level from about 75 to about 80 (about 70 Brix to about 80 Brix). An elevated temperature of the melt should be maintained to prevent pre-gelling upon combining part B and part A, and to allow proper depositing of the gummies in a liquid state since gelling of pectin is irreversible. In one embodiment, the melt should be maintained at about 90° C. to 100° C. (194 F.° to 212 F°), above the gelling point of the pectin. If the dissolved solids level is below 75, the melt should continue to be heated until the target dissolved solids level is achieved. Evaporation of the water will cause the dissolved solids level to continue to rise. If the dissolved solids level is above the target range, an amount of water should be added to the melt to adjust the dissolved solids level down to the target range.

Before the target dissolved solids range is reached, preferably less than 75 dissolved solids, other ingredients (such as functional ingredients) can be mixed into the melt, such as using a whisk. The melt temperature should be maintained at between about 90° C. to 100° C. (194F° to 212 F°). The dissolved solids level should be measured again. The target dissolved solids level should be about 75 to about 80 (about 70 Brix to about 80 Brix) and adjusted as appropriate if the dissolved solids level is not within target, as set forth herein. The melt should not exceed a dissolved solids level of about 80, otherwise the melt can pre-gel upon the addition of the acidulant (e.g., part B), causing the mixture to form clumps. This would make depositing the melt unsuitable.

The melt is then acidulated by vigorously mixing in the citric acid solution or other acidulant (e.g., part B) to achieve a pH of about 3.0 to about 3.7. At this point, the melt should be regulated at an elevated temperature of about 90° C. to 100° C. (194 F° to 212 F°), to prevent the melt from gelling before the melt can be deposited into molds.

Once the melt is fully homogenized, the gummy melt is ready to be deposited into molds (e.g., individual serving molds). The melt will gel quickly when the temperature drops so a depositor set at a temperature of about 93° C. to 104° C. (200° F.-220° F.) is a recommended way to deposit the gummy mix into individual serving gummy molds. For example, a suitable depositor will be one that has a heat jacketed hopper and heated nozzles.

The other ingredients (e.g., coloring, flavoring, functional) can be selected from preservatives, flavoring agents, coloring agent, isolates, distillates, extracts, functional ingredients, or combination of these ingredients. The other ingredients will be selected by the manufacturer based upon customer preferences. Preferably, the other ingredients are selected to maintain vegetarian or vegan labeling of the product. Packaging of the final individual serving gummies is also determined by manufacturer and customer preferences.

In a final step of preparing individual serving gummies, the gummies are popped out of the molds and dried. Prior to drying, the individual gummies can optionally be coated with a wax or anti-stick agent to provide a functional, non-stick, shiny and appealing finish to the gummies. Waxes and methods of applying the wax are known in the field. Suitable waxes and anti-stick agents include but are not limited to Carnauba or beeswax, lecithin, silicone-based spray, vegetable oil such as palm, sunflower or MCT oil, flour, starch such as cornstarch and potato starch, polyglycerol esters, and powdered cellulose, other powdered artificial or low-calories sweeteners. Alternatively, or in addition to waxing, the individual gummies can be sanded with other ingredients that are known to those in the field. Between waxing and sanding steps, the gummies should be allowed to dry. Ultimately, the final texture of the individual serving gummies is achieved after demolding during the curing/drying process. More drying time leads to a firmer and chewy gummy and a more shelf stable gummy. In embodiments, the final water activity of the gummy should be about 0.55 aw to about 0.70 aw, preferably about 0.60 aw to about 0.63 aw, to achieve desired product attributes including texture, mouthfeel and taste.

### Definitions

As used herein, singular articles such as “a,” “an” and “the,” and similar referents are to be construed to cover both the singular and the plural, unless otherwise indicated herein or brix clearly contradicted by context.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, ±10%, ±5% or ±1% of a given value. It is to be understood that the term “about” can precede any particular value specified herein.

Bulk is defined herein to mean a size and/or quantity of gummy mix packaged as a unit and offered as a precursor for making a plurality of individual serving gummies. A pectin-based gummy mix produced by the methods of the disclosure fall under the term bulk because it can be melted to make a plurality of individual serving gummies.

Gummy mix is intended to mean the melt comprising pectin, buffering salt (e.g., sodium citrate), bulking agent and sweetener, and water and optional finishing ingredients before it is gelled into individual serving gummies.

Individual gummies are intended to mean the molded and cured product of the method of mixing the gummy mix (e.g., part A) and an acidulant (e.g., part B). It should be understood that the methods disclosed herein produce a plurality of individual serving gummies and the number is determinant upon the amount of the gummy mix being used.

Storage stable is defined herein to mean an un-gelled pectin-based gummy mix precursor packaged under sanitary conditions. The pectin-based gummy mix should be stable (about 2 years of shelf life) when stored in the original sealed packaging under room temperature, and once opened stored at refrigerated temperature.

Precursor or intermediate are intended to be interchangeable terms and are defined herein to mean the pectin-based gummy mix in un-gelled form and the acidulant being used as bulk ingredients to be melted, molded and cured into individual serving gummies.

Individual serving size is intended to cover the final gummy product of any size or shape and consumed by an individual in an amount of 1 or multiple gummies. For example, the size of the gummy can be from about 1 gram to about 20 grams. It should be appreciated that the serving size and shape are factors determined by the gummy manufacturer based on manufacturer and customer preferences.

Total dissolved solids (TDS) is a measure of the dissolved combined content of all inorganic and organic substances present in a liquid in molecular, ionized, or micro-granular (colloidal sol) suspended form. TDS can be measured a number of different ways, including but not limited to, brix meter, refractometer, digital density meter, hydrometer and pycnometer.

Distillate is a refined oil of plant extract, isolate refers to the pure crystals form of specific compounds, such as but not limited to cannabinoid, (CBD, THC, etc.). Oil-soluble and water-soluble functional ingredients can be incorporated into the gummy matrix, which include but are not limited to Cannabis/CBD extracts, THC, minerals and vitamins, amino acids, caffeine, melatonin. A preferred ingredient that can be incorporated into the bulk pectin-based gummy mix is cannabis or extract thereof. Any of these can be added to the bulk pectin-based gummy mix, for example, in an amount of extract at the request of the customer (size of the finished gummy and dosage per serving).

Total dissolved solids (TDS) is a formulation/process parameter that controls the gelling effects of the High Methoxyl (HM) pectin. In process control, it is often measured by a brix meter based on the refractive index of the solution/mixture. Brix is created to determine the concentration of a sucrose solution by converting the refractive index of the sucrose solution to brix. Due to the ‘sugar free’ ingredient having variable refractive index different from sucrose solution, the Brix % of each soluble ingredient in the formula is measured and calculated below:

$$Brix {\%}_{Ingredient} = \frac{Measured brix level}{concentration of solution ( \% ) \times 100}$$

The Brix % of the formulation (Brix % Total) is the weighted average of the brix % of each soluble ingredient in the formula. The desired final brix level is then converted:

$$Final Brix = Depositing total solids ( TDS ) \times Brix {\%}_{Total}$$

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A bulk, meltable and storage stable preformulated pectin-based gummy mix that is a meltable precursor for making storage stable individual serving reduced sugar or sugar-free pectin-based gummies, the preformulated pectin-based gummy mix comprising:
a pectin-based gummy mix comprising dissolved pectin, optional buffering salt, bulking agent and/or sugar substitute and water, the amount collectively being present to achieve a dissolved solids content between about 60 to about 75, a pH of from about 4 to about 4.6 and a water activity of about 0.75 aw to about 0.85 aw; and optionally flavoring and/or coloring incorporated into the pectin-based gummy mix,
wherein sweetness is provided from the bulking agent and/or the sugar substitute, and wherein the preformulated pectin-based gummy mix is storage stable and a meltable precursor for making storage stable individual serving reduced sugar or sugar-free pectin-based gummies.

2. The preformulated bulk pectin-based gummy mix of claim 1, wherein the pectin is a buffered pectin, and the gummy mix can further comprise an edible food grade acid.

3. The preformulated bulk pectin-based gummy mix of claim 1, wherein when the buffering salt is present, the gummy mix can further comprise an edible food grade acid.

4. The preformulated bulk pectin-based gummy mix of claim 1, wherein the bulk pectin-based gummy mix further comprises at least one other ingredient selected from a preservative, flavoring agent, coloring agent, isolate, distillate, extract or functional ingredient.

5. The preformulated bulk pectin-based gummy mix of claim 1, wherein the bulk pectin-based gummy mix comprises a flavoring agent, a color agent or combination thereof.

6. The preformulated bulk pectin-based gummy mix of claim 1, wherein when the buffering salt is present, the buffering salt is sodium citrate, potassium polyphosphate, sodium tartrate, potassium tartrate, calcium citrate or potassium citrate, or combination of these.

7. A kit for making storage stable individual serving reduced sugar or sugar-free pectin-based gummies using a preformulated storage stable, meltable pectin-based gummy mix, the kit comprising:
part A comprising a preformulated, meltable, storage stable pectin-based mix comprising pectin, optional buffering salt, bulking agent and/or sugar substitute, and water and having a dissolved solid content of about 60 to about 75, a pH of from about 4 to about 4.6 and a water activity of about 0.75 aw to about 0.85 aw, and optionally comprising flavoring and/or coloring, wherein sweetness is provided from the bulking agent and/or sugar substitute; and
part B comprising an acidulant solution comprising from about 40% by weight to about 60% by weight of an edible acidulant dissolved in water.

8. The kit of claim 7, wherein the acidulant in part B is a citric acid solution in a concentration of from about 40% by weight to about 60% by weight.

9. The kit of claim 7, wherein part A further comprises at least one other ingredient selected from a preservative, flavoring agent, coloring agent, isolate, distillate, extract or functional ingredient.

10. The kit of claim 7, wherein part A comprises a flavoring agent, a color agent or combination thereof.

11. A method of making a preformulated, storage stable bulk pectin-based gummy mix that is a meltable precursor for making storage stable individual serving reduced sugar or sugar-free pectin-based gummies, comprising:
heating a pectin-based mixture comprising pectin, bulking agent and/or sugar substitute and optional buffering salt in water, for a period of time sufficient to dissolve the pectin-based mixture, the amount of ingredients in the pectin-based mixture collectively being present to achieve a dissolved solids content between about 60 to about 75, a pH of from about 4 to about 4.6 and a water activity of about 0.75 aw to about 0.85 aw, wherein the sweetness is provided from the bulking agent and/or sugar substitute, to produce a meltable pectin-based gummy mix precursor that is preformulated for making storage stable individual serving reduced sugar or sugar-free pectin-based gummies;
optionally adding flavoring and/or coloring to the pectin-based gummy mix before the mix is cooled; and
storing the preformulated pectin-based gummy mix in a container for a period of time before being used as a meltable precursor.

12. The method of claim 11, further comprising incorporating into the pectin-based gummy mix at least one additional ingredient selected from a preservative, flavoring agent, coloring agent, isolate, distillate, extract or functional ingredient.

13. The method of claim 11, wherein the pectin-based gummy mix comprises a flavoring agent, a color agent or combination thereof.

14. The method of claim 11, wherein the buffering salt when present is sodium citrate, potassium polyphosphate, sodium tartrate, potassium tartrate, calcium citrate or potassium citrate, or combination of these.

15. A method for making storage stable individual serving reduced sugar or sugar-free pectin-based gummies using a preformulated, storage stable, meltable bulk pectin-based gummy mix, comprising:
heating the pectin-based gummy mix of claim 1 to a temperature to prevent pre-gelling and to solubilize the solids in the mix to achieve a dissolved solids measurement of about 75 to about 80, to create a pectin-based gummy melt having a water activity of about 0.55 aw to about 0.70 aw;
optionally incorporating at least one other ingredient into the pectin-based gummy melt and adjusting the dissolved solids measurement, if needed, to about 75 to about 80;
mixing an acidulant into the heated pectin-based gummy melt to achieve a pH of from about 3.0 to about 3.7, to thereby initiate gelling of the pectin; and
depositing the pectin-based gummy melt into individual serving molds and allowing the pectin-based gummy melt cool and gel to produce storage stable individual serving reduced sugar or sugar-free pectin-based gummies.

16. The method of claim 15, wherein at least one other ingredient, when present, is selected from a preservative, flavoring agent, coloring agent, isolate, distillate, extract or functional ingredient.

17. The method of claim 16, wherein the functional ingredient is at least one selected from Cannabis/CBD extracts, THC, minerals and vitamins, amino acids, caffeine, melatonin and extracts.

18. The method of claim 15, wherein the buffering salt when present in the pectin-based gummy mix is sodium citrate, potassium polyphosphate, sodium tartrate, potassium tartrate, calcium citrate or potassium citrate, or combination of these.

19. The method of claim 15, wherein the acidulant is a citric acid solution in a concentration of from about 40% by weight to about 60% by weight.

20. The method of claim 15, further comprising removing the individual serving sugar free pectin-based gummies from the molds and applying a coating of wax, oil or anti-stick agent, starch, non-nutritive sugar replacement as a sanding sugar.

21. A method for making storage stable individual serving reduced sugar or sugar-free pectin-based gummies from the kit of claim 7, comprising:
heating the part A pectin-based gummy mix to a temperature to prevent pre-gelling and to solubilize the solids in the mix to achieve a dissolved solids measurement of about 75 to about 80, to create a pectin-based gummy melt having a water activity of about 0.55 to about 0.70 aw;
optionally incorporating at least one other ingredient into the pectin-based gummy melt and adjusting the dissolved solids measurement, if needed, to about 75 to about 80;
mixing the part B acidulant solution into the heated pectin-based gummy melt to achieve a pH of from about 3.0 to about 3.7, to thereby initiate gelling of the pectin; and
depositing the pectin-based gummy melt into individual serving molds and allowing the pectin-based gummy melt to cool and gel to produce storage stable individual serving reduced sugar or sugar-free pectin-based gummies.

22. A kit for making storage stable individual serving reduced sugar or sugar-free pectin-based gummies, comprising:
containers separately storing part A and part B of the kit of claim 7;
instructions for mixing part A and part B to make storage stable individual serving reduced sugar pectin-based gummies; and
optionally comprising at least one of anti-stick agent, wax and oil, molds and scraper.

23. The preformulated bulk pectin-based gummy mix of claim 1, wherein the bulking agent and/or sugar substitute is tapioca fiber or corn fiber, and inulin, optionally erythritol and/or other sugar alcohols, and/or high intensity sweeteners.
